(19) United States
(12) Patent Application Publication
(10) Pub. No.: US 2026/0192753 A1
(43) Pub. Date: Jul. 9, 2026

(54) VEHICLE MOVING CONSOLE DEVICE

(71) Applicants: Hyundai Motor Company, Seoul (KR); Kia Corporation, Seoul (KR); NIFCO KOREA Inc., Asan-si, Chungcheongnam-do (KR)

(72) Inventors: Jeong Min YUN, Hwaseong-Si (KR); Su Kyeong KIM, Hwaseong-Si (KR); Sung Sik CHOI, Hwaseong-Si (KR); Byung Seok KONG, Hwaseong-Si (KR); Geun Heung KIM, Asan-si (KR)

(21) Appl. No.: 19/289,567

(22) Filed: Aug. 4, 2025

(30) Foreign Application Priority Data
Jan. 6, 2025 (KR) 10-2025-0001327

(51) Int. Cl. B60R 7/04; B60N 3/10

(52) U.S. Cl. CPC B60R 7/04; B60N 3/10

(57) ABSTRACT

A vehicle moving console device is configured to lock and fix a console to a desired position on a seamless long sliding rail mounted on a floor panel of a vehicle, to unlock the console from the long sliding rail so as to move the console to a desired position on the long sliding rail, to readily supply power to electrical components included in the console even if the console is moved to the desired position, and to remove the console from the long sliding rail so as to maximally utilize the interior space of the vehicle.

### CROSS-REFERENCE TO RELATED APPLICATION

This application claims, under 35 U.S.C. §119(a), the benefit of priority from Korean Patent Application No. 10-2025-0001327, filed on January 6, 2025, the entire contents of which are incorporated herein by reference.

### TECHNICAL FIELD

The present disclosure relates to a vehicle moving console device, and more particularly, to a vehicle moving console device capable of moving a console to a desired position along a seamless long sliding rail and removing the console from the long sliding rail as necessary.

### BACKGROUND

A vehicle console may be installed between the driver's seat and the passenger seat and may be used to store various items therein, for example. The console may have an armrest installed on the upper portion thereof in an openable and closable manner and configured to allow the arms of a driver and a passenger to rest thereon.

Although the console provides such convenience to a driver and a passenger, the console occupies a lot of space in the vehicle interior and has a single box structure configured to simply provide a storage space and is fixedly mounted on the floor panel, which may cause deterioration in space utilization and functional usability. Further, it is difficult for a passenger sitting on the rear seat to directly use the console.

In the case of autonomous electric vehicles, since an interior floor panel having a flat shape is applied to the vehicle interior (e.g., due to removal/lack of an engine and a drive shaft), the seats on which a driver and a passenger are seated may be moved forwards and rearwards and/or may be swiveled to a desired position/orientation. If the console is fixedly mounted on the floor panel as described above, when the seat is moved forwards and rearwards, a distance between the console and the seat increases and as such, a driver and a passenger may experience inconvenience in using the console and the armrest.

At least to address the above problems, there is a need for various mechanisms such as a mechanism through which a console is movable to a position allowing passengers sitting on the front and rear seats to use the console, a mechanism through which, in addition to the item storage function of a console, various convenience functions are added to the console, and a mechanism through which a console is detachable as necessary to maximally utilize the interior space of a vehicle.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses, and methods are described for a vehicle moving console device. A vehicle moving console device may comprise: rails mounted on a floor panel; wheels mounted on lower portions of opposite sides of a console and configured to be mounted on the rails so as to be movable forwards and rearwards along the rails; a lock, mounted on the console and the rails, configured to be locked to lock the console to the rails such that the console is movable along the rails, or to be unlocked to unlock the console from the rails such that the console is removable from the rails; a locking release lever, mounted on the console, configured to unlock the lock; a fixed plate configured to connect the rails; and a power supply mounted on the fixed plate and the console.

These and other features and advantages are described in greater detail below.

### BRIEF DESCRIPTION OF THE DRAWINGS

The above and other features of the present disclosure will now be described in detail with reference to certain examples thereof illustrated in the accompanying drawings which are given hereinbelow by way of illustration only, and thus are not limitative of the present disclosure, and wherein:

FIG. 1 is an external perspective view of a vehicle moving console device according to the present disclosure;

FIG. 2 is an exploded perspective view of the internal configuration of the vehicle moving console device according to the present disclosure;

FIG. 3 is a front cross-sectional view showing a locked state of a console in the vehicle moving console device according to the present disclosure;

FIG. 4 is a front cross-sectional view showing an unlocked state of the console in the vehicle moving console device according to the present disclosure;

FIG. 5 is a side cross-sectional view showing an operation in which a slider is moved upwards when a first release lever is manipulated in the vehicle moving console device according to the present disclosure;

FIG. 6 is a side cross-sectional view showing an operation in which the slider is moved upwards when a second release lever is manipulated in the vehicle moving console device according to the present disclosure;

FIG. 7 is a cross-sectional view of a main part of the vehicle moving console device according to the present disclosure, showing an operation of detecting that a locking pin is inserted into a correct locking position;

FIG. 8 is a cross-sectional view of a main part of the vehicle moving console device according to the present disclosure, showing an operation of detecting that the locking pin is inserted into an incorrect locking position;

FIG. 9A is a cross-sectional view of a main part of the vehicle moving console device according to the present disclosure, showing a state in which a detachable bracket mounted on the console is coupled to a lower locking bracket;

FIG. 9B is a cross-sectional view of a main part of the vehicle moving console device according to the present disclosure, showing an operation of separating the detachable bracket from the lower locking bracket in order to detach the console;

FIG. 10 is an exploded perspective view of a power supply device of the vehicle moving console device according to the present disclosure;

FIG. 11 is an assembled perspective view of the power supply device of the vehicle moving console device according to the present disclosure; and

FIGS. 12A to 12E are cross-sectional views of a main part of the vehicle moving console device according to the present disclosure, sequentially showing operations in which an upper pogo pin and a lower pogo pin of the power supply device are in conductive contact with each other when the console is moved.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various examples of the present disclosure, examples of which are illustrated in the accompanying drawings and described below. Specific structural or functional descriptions given in connection with the examples of the present disclosure are merely illustrative for the purpose of describing examples according to the concept of the present disclosure, and the examples according to the concept of the present disclosure may be implemented in various forms. Further, it will be understood that the present description is not intended to limit the disclosure to the examples. On the contrary, the present disclosure is intended to cover not only the examples, but also various alternatives, modifications, equivalents, and other examples, which may be included within the spirit and scope of the disclosure as defined by the appended claims.

In the present disclosure, terms such as "first" and/or "second", and the like, may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

If one component is referred to as being "connected" or "joined" to another component, the one component may be directly connected or joined to the other component (i.e., without any other component therebetween), but it should be understood that one or more other components may be present therebetween. On the other hand, when the one component is referred to as being "directly connected to" or "directly in contact with" the other component, it should be understood that no other component is present therebetween. Other expressions for the description of relationships between components, that is, "between" and "directly between" or "adjacent to" and "directly adjacent to", should be interpreted in the same manner.

The same reference numerals represent the same components throughout the specification. Additionally, the terms in the specification are used merely to describe examples and are not intended to limit the present disclosure. In this specification, an expression in a singular form also includes a plural form, unless clearly specified otherwise in context. As used herein, expressions such as "comprise" and/or "comprising" do not exclude the presence or addition of one or more components, steps, operations, and/or elements other than those described.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B. “One or more of” is synonymous with “at least one of” herein.

Depending on the context, the expression "configured to" as used herein may have meanings such as "set to", "with the ability to", "modified to", "made to", "to be able to", etc. This expression is not limited to the meaning of "specially designed in hardware to". For example, a processor configured to perform a specific operation may refer to a generic purpose processor capable of performing the specific operation by executing software, or to a special purpose computer structured through programming to perform the specific operation.

It is understood that the terms "vehicle", "vehicular", and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

In the present disclosure, one or more control devices (e.g., a controller, a control unit, etc.) may be realized as one or more processors and a memory. The one or more “processors” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. The control device may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

A control device/controller may include a communication device communicating with other controllers or a sensor to control one or more functions and/or operations in charge, a memory storing an operation system, a logic command, and input/output information, and/or one or more processors performing determination, calculation, and decision necessary for controlling the function in charge. A controller may manipulate and/or control other components (e.g., a vehicle moving console device and/or components thereof) in the system (e.g., vehicle).

A user interface may be a device through which a human user can interact with a device. The user interface may include an input interface that can receive an input from the human user and/or an output interface through which data or information can be output to the human user. An input interface may include, for example, a button, a knob, a toggle, a switch, a dial, a slider, a keyboard, a touchscreen, a microphone, a camera, a wheel, a pedal, a lever, etc. An output interface may include, for example, a light, a lamp, an indicator, a screen, a display, a console, a meter, a gauge, a speaker, etc.

The expression "based on" as used herein is intended to describe one or more factors that influence an act or operation of determining or deciding described in a phrase or sentence including that expression, and this expression does not exclude any additional factors that influence the act or operation of determining or deciding.

Hereinafter, examples of the present disclosure will be described in detail with reference to the accompanying drawings.

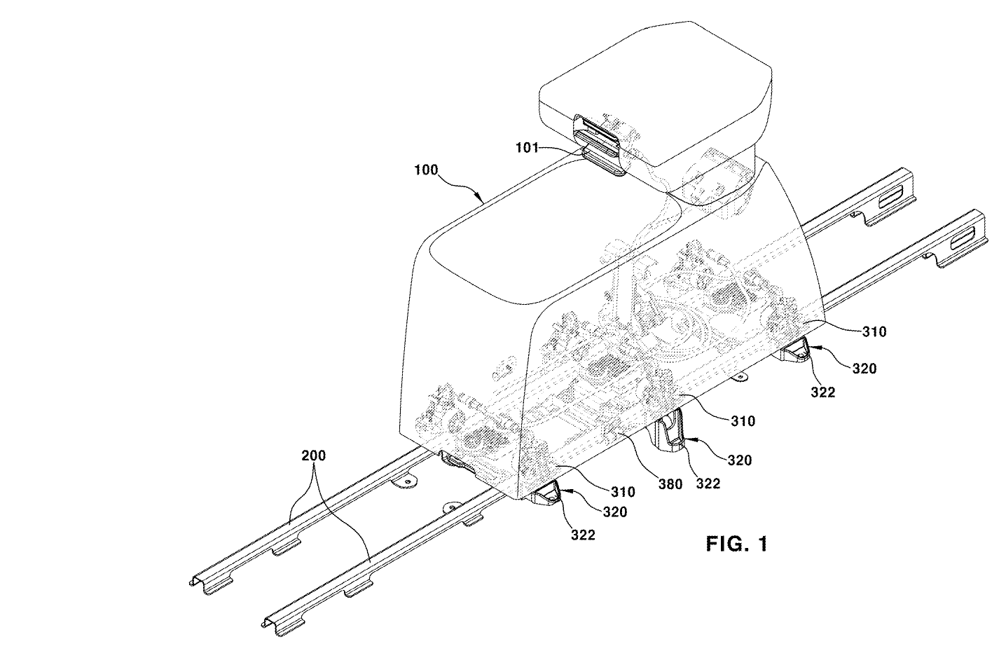

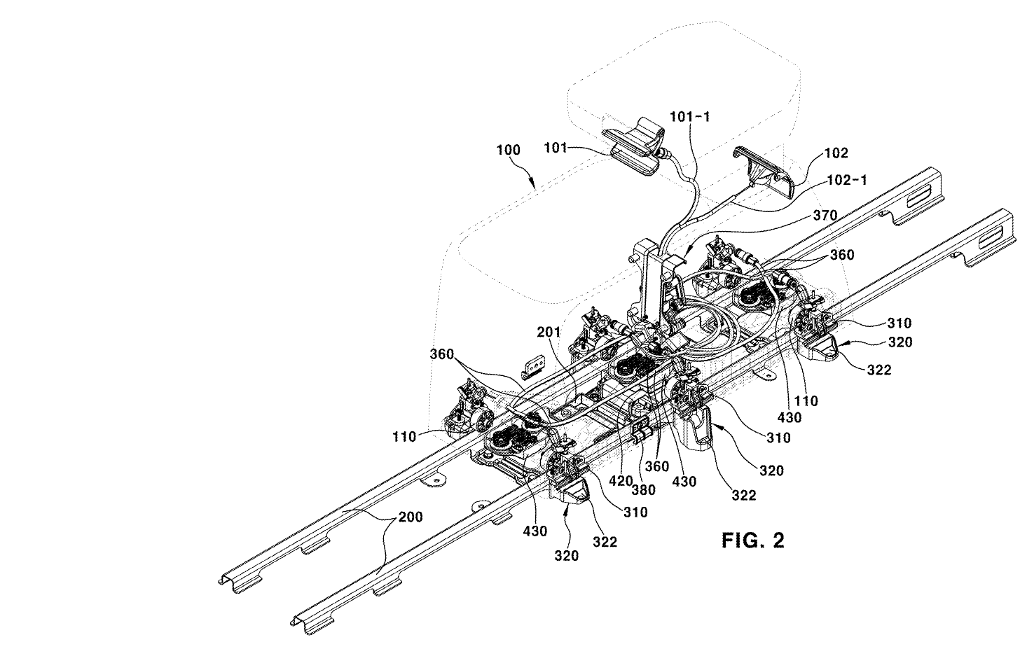

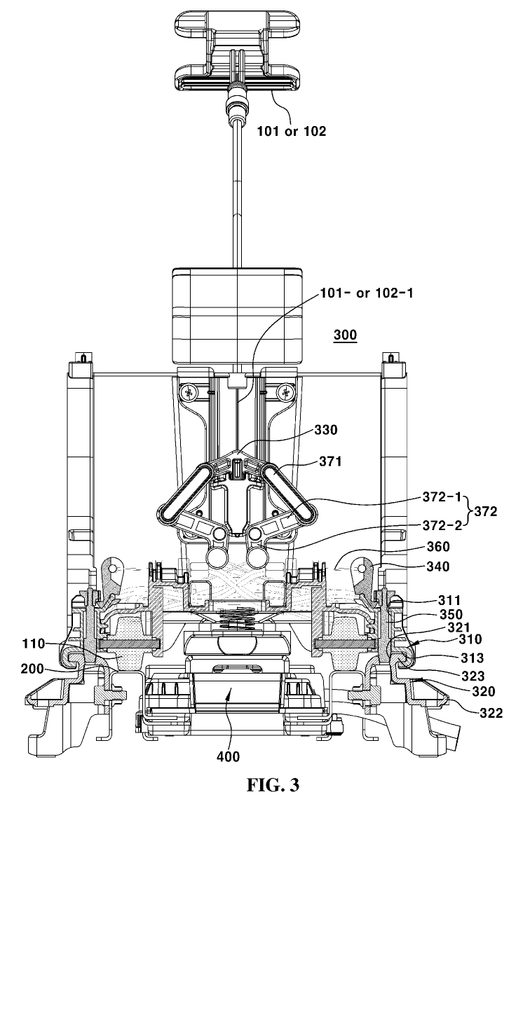

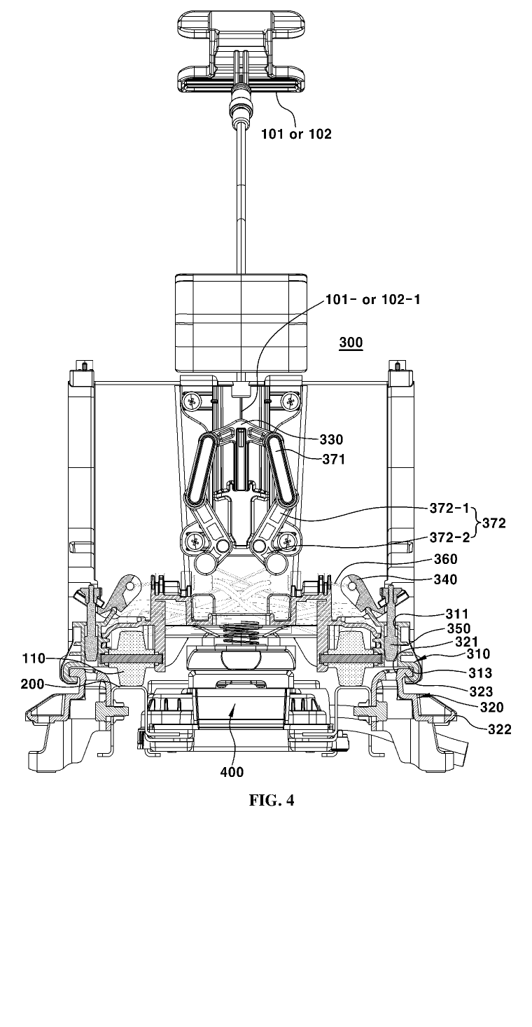

FIG. 1 is an external perspective view of a vehicle moving console device according to the present disclosure, FIG. 2 is an exploded perspective view of the internal configuration of the vehicle moving console device according to the present disclosure, and FIGS. 3 and 4 are front cross-sectional views of the vehicle moving console device according to the present disclosure.

As shown in FIGS. 1 and 2, a pair of rails 200 may be mounted on a floor panel forming the interior floor surface of a vehicle.

The rails 200 may be sliding rails formed to extend from a portion between the front seats of the vehicle toward the rear seats (e.g., towards, to within a typical arm length of and/or between a first row of rear seats, a second row of rear seats, etc.).

A console 100 may be mounted on the rails 200 so as to be movable forwards and/or rearwards along the rails. In this manner, the console 100 may be moved to a position allowing a passenger sitting on the front seat to use the console and/or a position allowing a passenger sitting on the rear seat to use the console.

To this end, a plurality of wheels 110 may be configured to be movable forwards and rearwards along the rails 200. The plurality of wheels 110 may be formed form a plastic material, for example. The plurality of wheels 110 may be respectively mounted on the lower portions of opposite sides of the console 100.

In an example, at least three wheels 110 may be mounted on each of the lower portions of a first side of the console 100 (e.g., associated with a first rail 200) and a second side of the console 100 (e.g., associated with a second rail 200). The at least three wheels 110 on a given side of the first side or the second side may be spaced with a predetermined interval therebetween in the forward-and-rearward direction (e.g., in longitudinal rail direction), thereby supporting the load of the console 100.

A locking device 300 (e.g., a lock) may be mounted on the console 100 and the rails 200. The locking device 300 may be configured to lock the console 100 to the rails 200 in a state in which the console 100 is movable to a desired position on the rails 200. Further, the locking device may be configured to be unlocked to allow the console 100 to be removed from the rails 200, thereby securing an increased/additional and/or sufficient space inside the vehicle.

The console 100 may have a locking release lever mounted at a predetermined position thereof and configured to unlock the locking device 300.

As shown in FIGS. 2, 5, and 6, for example, the locking release lever may comprise a first release lever 101 mounted at a predetermined position on the front side of the console 100. The first release lever 101 may be configured for a passenger sitting on the front seat to unlock the locking device 300. The locking release lever may further comprise a second release lever 102 mounted at a predetermined position on/towards the rear side of the console 100. The second release lever 102 may be configured for a passenger sitting on the rear seat to unlock the locking device 300.

A fixed plate 201 may be mounted between the pair of rails 200, and a power supply device 400 (e.g., a power supply) configured to supply power to electrical components (for example, a wireless charger and the like) provided in the console is mounted on the fixed plate 201 and the console 100.

Hereinafter, the detailed configuration and operation process of the locking device 300 will be described.

A plurality of upper locking brackets 310, each upper locking bracket 310 of which serving as a component of the locking device 300, may be mounted on each of the lower portions of the first and second sides of the console 100. The plurality of upper locking brackets 310 may be spaced with a predetermined interval therebetween in the forward-and-rearward direction.

In an example, at least three upper locking brackets 310 may be mounted on each of the lower portions of the first and second sides of the console 100 with a predetermined interval therebetween in the forward-and-rearward direction. Each of the upper locking brackets 310 may form a locking pin lifting/lowering hole 311 vertically passing therethrough.

A plurality of lower locking brackets 320, each lower locking brackets 320 of which serving as a component of the locking device 300, may be mounted on each of the outer portions of the rails 200. The plurality of lower locking brackets 320 may be spaced apart with a predetermined interval therebetween in the forward-and-rearward direction.

In an example, at least three lower locking brackets 320 may be mounted on each of the outer portions of the rails 200 with a predetermined interval therebetween in the forward-and-rearward direction. Each of the lower locking brackets 320 may form a locking pin locking hole 321 vertically passing therethrough.

As shown in FIG. 3, a locking pin 350 may be inserted into the locking pin lifting/lowering hole 311 of an upper locking bracket 310 (e.g., of each upper locking bracket 310 of the plurality of upper locking brackets 310) so as to be movable in the upward-and-downward direction. If/when the lower portion of the locking pin 350 is inserted into the locking pin locking hole 321 of the lower locking bracket 320, the console 100 may be locked to the rails 200, and movement of the console 100 may be restricted in the locked state of the console.

In order to perform upward-and-downward movement of the locking pin 350, the console may have a slider 330 mounted at a predetermined position on the inner surface of the console and configured to be vertically movable in the console. The slider 330 may be connected to the first release lever 101 by a first cable 101-1 and/or connected to the second release lever 102 by a second cable 102-1.

A connection end 331, forming a connection hole 332 through which the first cable 101-1 and the second cable 102-1 may be inserted, may be formed on the upper portion of the slider 330. Cable fixing caps 103 may be caught on the bottom surface of the connection end 331 and may be respectively attached to the ends of the first cable 101-1 and the second cable 102-1 (e.g., a first cable fixing cap 103 attached to the end of the first cable 101-1 and a second cable fixing cap 103 attached to the end of the second cable 102-1).

A lifting/lowering guide body 333 may extend from the lower portion of the connection end 331 of the slider 330. The console 100 may have a lifting/lowering guide rail 104 mounted at a predetermined position on the inner surface of the console 100. The lifting/lowering guide rail 104 may be configured to accept/accommodate the lifting/lowering guide body 333 (e.g., for the lifting/lowering guide body 333 to be inserted thereinto in a vertically movable manner).

The lifting/lowering guide rail 104 may form a lifting/lowering guide hole 105. The lifting/lowering guide hole 105 may be configured to accept/accommodate the lifting/lowering guide body 333 (e.g., for the lifting/lowering guide body 333 to be inserted thereinto in a vertically movable manner).

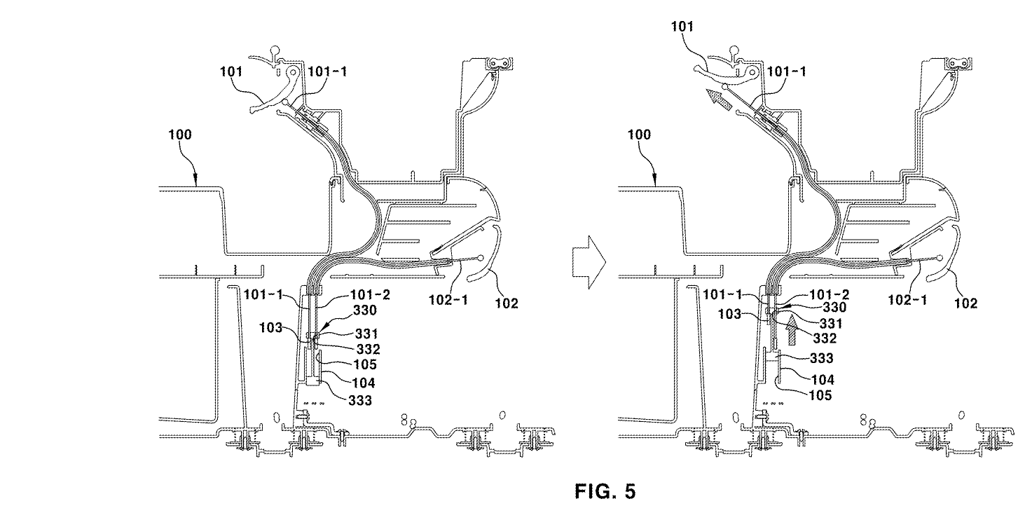

As shown in FIG. 5, the slider 300 may be moved upwards by sequentially performing an operation through which the first cable 101-1 is pulled via operation of the first release lever 101 in the unlocking direction. Operating the first release lever 101 to cause puling the first cable 101-1 in the unlocking direction may cause the connection end 331 of the slider 330 to be pulled upwards by/via the cable fixing cap 103 attached to the end of the first cable 101-1. By the connection end 331 being pulled upwards, the lifting/lowering guide body 333 connected to the lower portion of the connection end 331 may be moved upwards along the lifting/lowering guide hole 105 of the lifting/lowering guide rail 104.

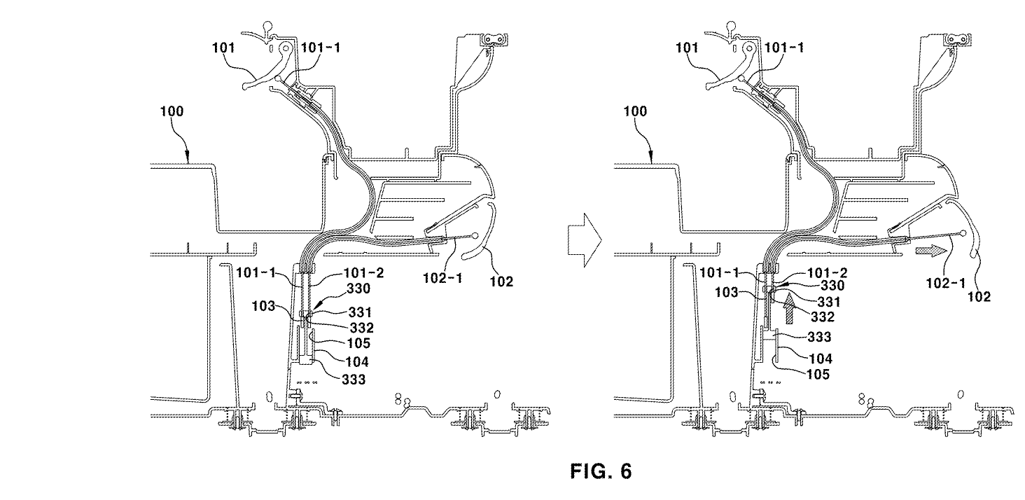

Also, or alternatively, as shown in FIG. 6, the slider 300 may be moved upwards by sequentially performing an operation through which the second cable 102-1 is pulled via operation of the second release lever 102 in the unlocking direction. Operating the second release lever 101 to cause puling the second cable 102-1 in the unlocking direction may cause the connection end 331 of the slider 330 to be pulled upwards by/via the cable fixing cap 103 attached to the end of the second cable 102-1. By the connection end 331 being pulled upwards, the lifting/lowering guide body 333 connected to the lower portion of the connection end 331 may be moved upwards along the lifting/lowering guide hole 105 of the lifting/lowering guide rail 104.

Based on/by the lifting/lowering guide body 333 of the slider 330 being moved upwards or downwards along the lifting/lowering guide hole 105 of the lifting/lowering guide rail 104 of the console 100, the linear movement trajectory of the slider 330 in the vertical direction may be maintained constant.

A link device 370 may be connected to the slider 330 in a foldable manner for upward-and-downward movement of the locking pin 350. The link device 370 may comprise a pair of intermediate links 371 and a pair of driving links 372, as shown in FIGS. 3 and 4.

The upper portions of the pair of intermediate links 371 may be respectively hinged to both ends of the slider 330. The middle portions of the pair of driving links 372 may be respectively hinged to predetermined positions on the inner surface of the console 100.

Inclined links 372-1 respectively hinged to the lower portions of the pair of intermediate links 371 may be integrated with and/or extend from respective upper portions of the middle portions of the pair of driving links 372. Cable pulling links 372-2 may be integrated with and/or extend from the respective lower portions of the middle portions of the pair of driving links 372.

A first of a third cable 360 may be connected to the cable pulling link 372-2 of the driving link 372. A second end of the third cable 360 (e.g., opposite to the first end) may be connected to a locking pin lifting/lowering operation lever 340 adapted to perform upward-and-downward movement of the locking pin 350.

The locking pin lifting/lowering operation lever 340 may be hinged to the upper locking bracket 310. The locking pin lifting/lowering operation lever 340 may be connected to the tip of the locking pin 350 (e.g., so as to move the locking pin 350 upwards).

A hinge end 312 may be formed on the upper portion of the upper locking bracket 310. The locking pin lifting/lowering operation lever 340 may have an inner surface that forms a hinge groove 341. The hinge groove 341 may be configured to accept/accommodate the hinge end 312 (e.g., for the hinge end 312 to be inserted into the hinge groove 341 and be coupled thereto).

A cable connection end 342 connected to the second end of the third cable 360 and a lifting end 343 configured to move the locking pin 350 upwards may be respectively formed on the upper side and the outer side of the hinge groove 341 of the locking pin lifting/lowering operation lever 340.

When/if the slider 330 is moved upwards (e.g., as described herein), the intermediate link 371 may be pulled upwards, as shown in FIG. 4, and the intermediate link 371 pulls the inclined link 372-1 of the driving link 372 upwards. In this manner, if the driving link 372 is rotated, the cable pulling link 372-2 may pull the third cable 360.

If the third cable 360 is pulled, the locking pin lifting/lowering operation lever 340 may be rotated in the unlocking direction around the hinge end 312 of the upper locking bracket 310, thereby allowing the lifting end 343 of the locking pin lifting/lowering operation lever 340 to move the locking pin 350 upwards.

As shown in FIG. 4, the locking pin 350 may be moved upwards and exit from the locking pin locking hole 321 of the lower locking bracket 320. The console 100 may be unlocked by the locking pin 350 being removed from the locking pin locking hole 321, such that the wheels 110 of the console 100 may be movable along the rails 200.

When/if a user pushes the console 100 forwards or rearwards, when the console is unlocked/moveable, the console 100 may be moved to a desired position along the rails 200.

A first electrode 351 connected to a first polarity (e.g., +) power source may be attached to the upper front surface of the locking pin 350. A second electrode 352 connected to a second polarity (e.g., -) power source may be attached to a portion between the cable connection end 342 and the lifting end 343 of the locking pin lifting/lowering operation lever 340 so as to conductively contact the first electrode 351. Also, or alternatively, this polarity may be switched.

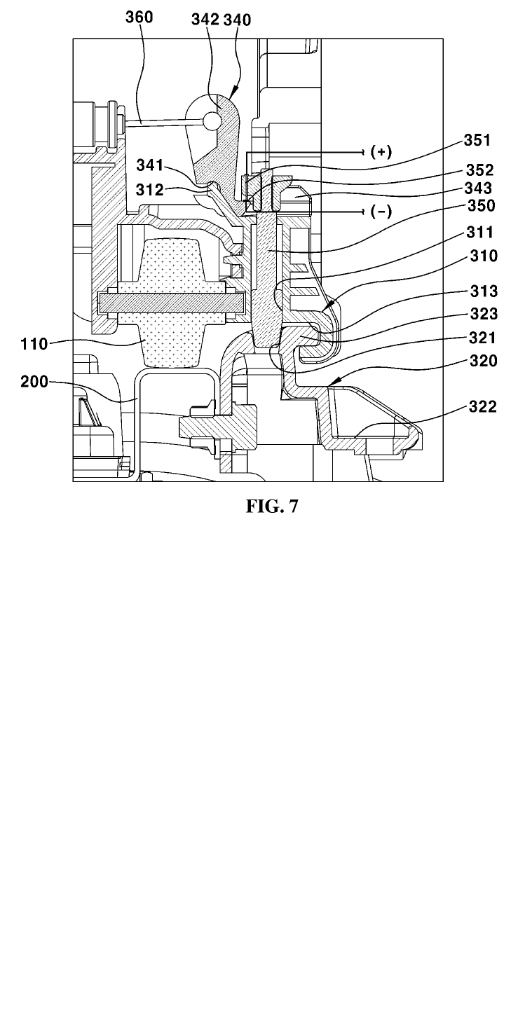

As shown in FIG. 7, when/if the first electrode 351 and the second electrode 352 are in contact with each other in a conductive manner, a controller (not shown) may recognize (e.g., via an electrical signal indicative of the conductive contact) that the locking pin 350 is normally locked and inserted into the locking pin locking hole 321 of the lower locking bracket 320.

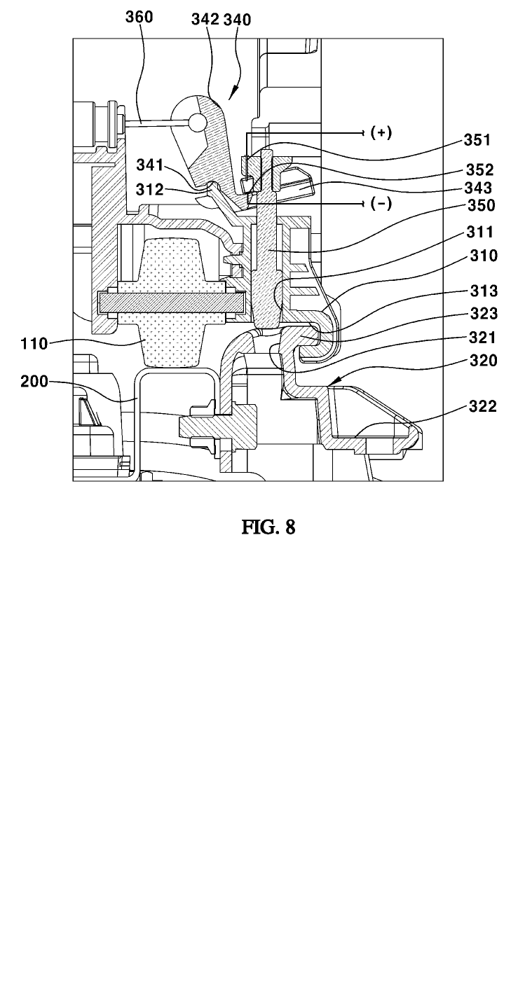

As shown in FIG. 8, when/if the locking pin 350 is incompletely locked and inserted into the locking pin locking hole 321 of the lower locking bracket 320, the first electrode 351 and the second electrode 352 do not contact each other. Accordingly, the controller (not shown) may recognize that the locking pin 350 is incompletely locked and inserted thereinto (e.g., due to lack of/insufficient electrical signal indicative of the conductive contact). The controller may cause output of a warning signal (e.g., via a user interface) notifying the user of the incomplete insertion state.

Referring to FIGS. 3 and 4, a locking groove 313 may be formed in the lower inner surface of the upper locking bracket 310 mounted on the console 100. The lower locking bracket 320 may include an upper outer surface that forms a locking end 323 that may be inserted into and coupled to the locking groove 313 so as to be movable forwards and rearwards in the locking groove 313.

Since the locking end 323 of the lower locking bracket 320 is inserted into the locking groove 313 of the upper locking bracket 310 at a position where the console 100 may be locked or unlocked by the locking pin 350, it may be possible to reliably prevent the console 100 from being separated from the rails 200 due to external impact.

A lower outer side of the lower locking bracket 320 may form and/or be integrated with a mounting end 322 mounted on the floor panel. The mounting end 322 may improve rigidity of the lower locking bracket 320, and/or may prevent the locking end 323 of the lower locking bracket 320 from being separated from the locking groove 313 of the upper locking bracket 310 (e.g., due to external impact).

As shown in FIG. 2, for example, in order to remove the console 100 from the rails 200, detachable brackets 380 may be respectively mounted on the lower ends of opposite sides of the console 100 and may be arranged between the upper locking brackets 310.

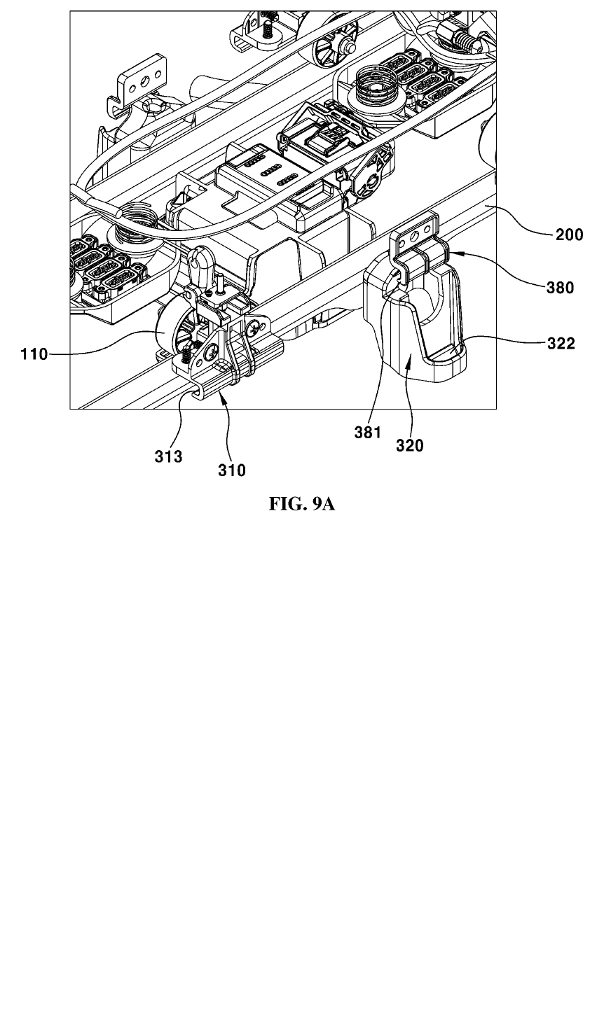

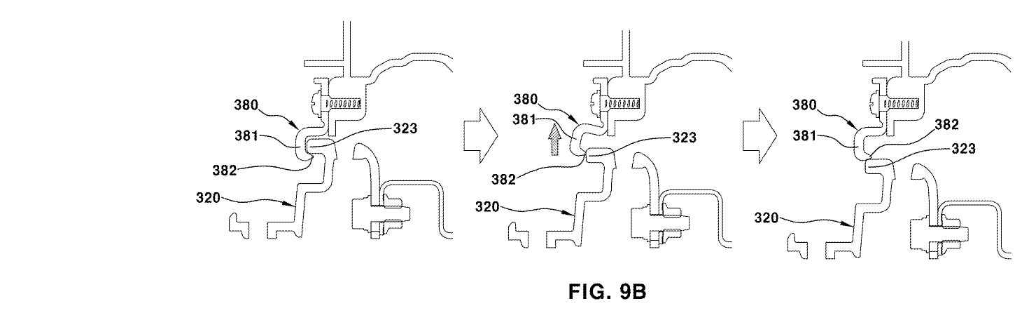

As shown in FIG. 9B, the detachable bracket 380 may have an elastic hook 381 formed on the lower portion thereof and detachably coupled to the locking end 323 of the lower locking bracket 320.

The elastic hook 381 may have an inclined surface 382 formed on the bottom surface thereof. The inclined surface may be inclined at a predetermined angle relative to the upper surface of the locking end 323 so as to allow the elastic hook 381 to be smoothly mounted on and removed from the locking end 323.

When/if the console 100 is moved (e.g., by a predetermined distance/position) to remove the console 100 from the rails 200 (e.g., as shown in FIG. 9A), the detachable bracket 380 moved with the console 100 may be coupled to the lower locking bracket 320 mounted on the rails 200.

When/if the console 100 is moved (e.g., by a predetermined distance/position) to remove the console 100 from the rails 200, the elastic hook 381 of the detachable bracket 380 moved with the console 100 may be hooked on the lower portion of the locking end 323 of the lower locking bracket 320 and may be maintained in a locked state.

As shown in FIG. 9B, when/if the elastic hook 381 of the detachable bracket 380 is moved outwards and is lifted upwards (e.g., by a user), the elastic hook 381 may be separated from the locking end 323 of the lower locking bracket 320, thereby allowing the console 100 to be removed from the rails 200. Accordingly, since the console 100 is removed from the rails 200, the interior space of the vehicle may be efficiently/differently utilized and/or available.

The fixed plate 201 and the console 100 mounted between the pair of rails 200 are equipped with a power supply device for an electrical component 400 configured to supply power to an electrical component such as a wireless charger included in the console.

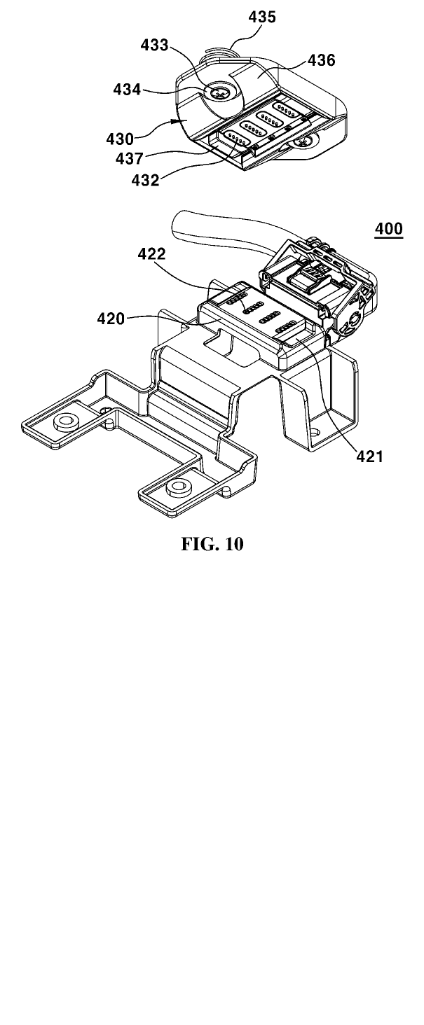

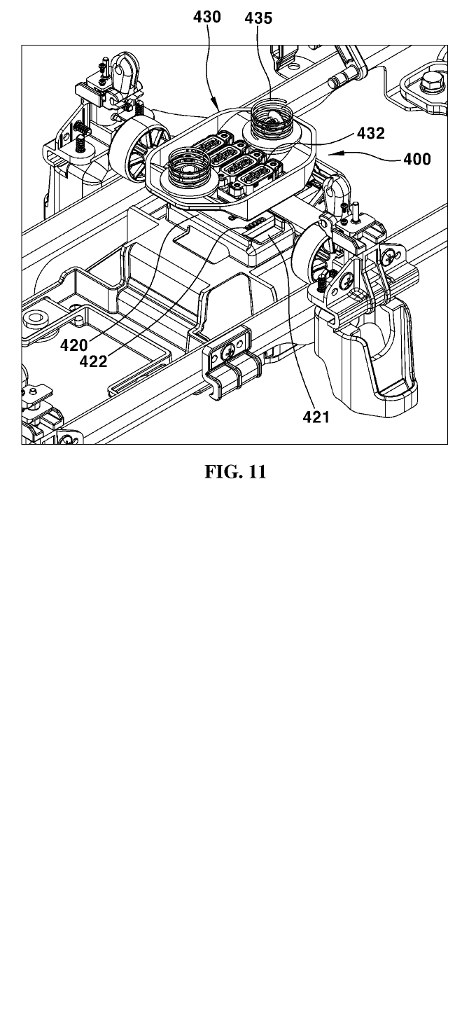

To this end, as shown in FIGS. 10 and 11, the power supply device for an electrical component 400 may include a fixed housing 420 mounted on the fixed plate 201, a plurality of lower pogo pins 422 mounted on the upper surface of the fixed housing 420 in a predetermined arrangement and configured to receive power from the controller (not shown), a movable housing 430 mounted on the lower portion of the console 100 and configured to be moved with the console, and a plurality of upper pogo pins 432 mounted on the lower surface of the movable housing 430 in a predetermined arrangement so as to be in conductive contact with the lower pogo pins 422.

As shown in FIG. 2, considering that the console 100 is movable forwards and rearwards, at least three movable housings 430, each including the upper pogo pins 432, may be mounted on the lower portion of the console 100 with an equal interval therebetween in the longitudinal direction of the console.

A screw coupling end 106 may be formed on the bottom surface of the console 100, and coupling holes 431, each configured for the screw coupling end 106 to be inserted therethrough, are respectively formed at the front portion and the rear portion of the movable housing 430.

A screw 433 may be coupled to the screw coupling end 106 inserted through a coupling hole 431, of the coupling holes of the movable housing 430, and a stopper 434 configured to support the front and rear bottom surfaces of the movable housing 430 may be coupled to the head of the screw 433.

Springs 435 may be inserted into and arranged in the circumferential portion of the screw coupling end 106. The springs 435 may be arranged in a compressible manner between the upper surface of the movable housing 430 and the lower surface of the console 100.

Slide protrusions 436, each inclined at a predetermined inclination angle, are respectively formed at the front and rear portions on the bottom surface of the movable housing 430 and are formed to protrude downwards so as to contact a front corner portion or a rear corner portion of the fixed housing 420.

Furthermore, tolerance absorbing protrusions 437 are respectively formed at both portions on the lower surface of the movable housing 430, and tolerance absorbing grooves 421 configured for the tolerance absorbing protrusions 437 to be respectively inserted thereinto and coupled thereto are respectively formed at both portions on the upper surface of the fixed housing 420.

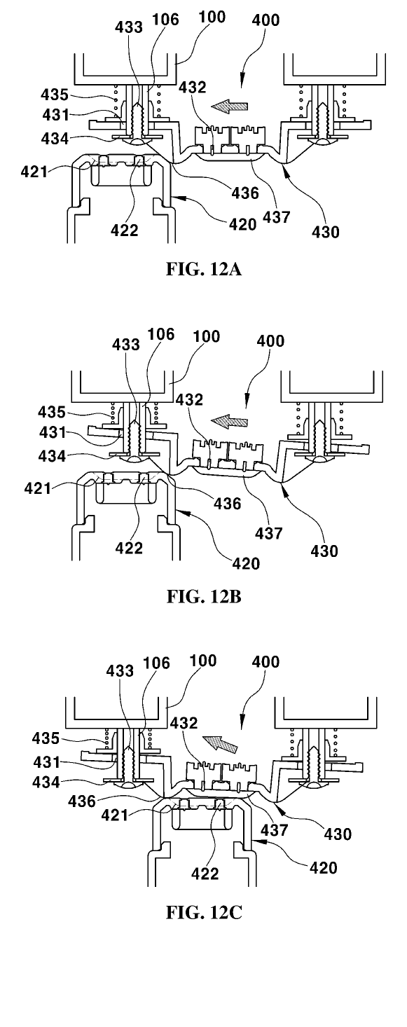

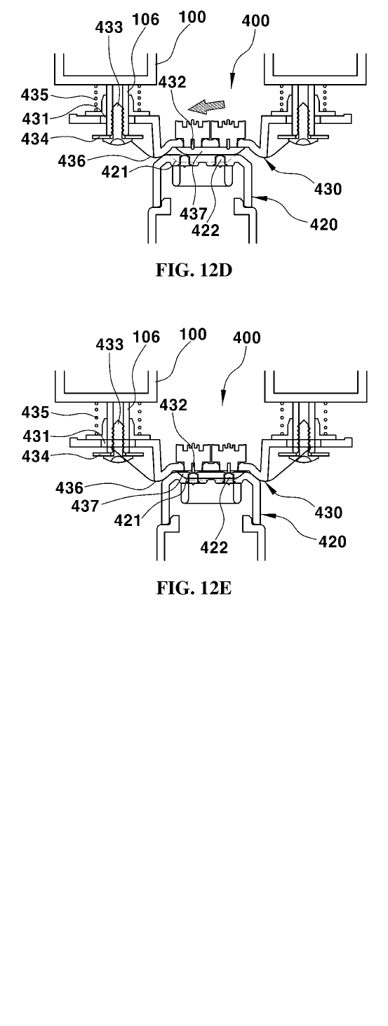

Hereinafter, an operation flow of the power supply device having the above-described configuration is described with reference to FIGS. 12A to 12E.

The console 100 may be moved along the rails 200 towards the fixed housing 420 (e.g., front or rear). As shown in FIG. 12A, the slide protrusion 436 formed at the front portion or the rear portion on the bottom surface of the movable housing 430 may come into contact with one corner portion of the fixed housing 420.

When/if the slide protrusion 436 of the movable housing 430 comes into contact with the upper surface of the fixed housing 420, as shown in FIG. 12B and FIG. 12C, the spring 435 (e.g., over the fixed housing 420) may be compressed, and one end of the movable housing 430 may be moved upwards.

When/if the console 100 is further moved along the rails 200, as shown in FIG. 12D, the slide protrusion 436 formed at the front portion or the rear portion on the bottom surface of the movable housing 430 may come into contact with the other corner portion of the fixed housing 420 and may move downwards. As shown in FIG. 12E, the tolerance absorbing protrusion 437 of the movable housing 430 may be inserted into the tolerance absorbing groove 421 of the fixed housing 420.

Accordingly, the upper pogo pins 432 of the movable housing 430 and the lower pogo pins 422 of the fixed housing 420 may be in conductive contact with each other.

Therefore, power applied from the controller (not shown) may be reliably supplied to various electrical components mounted on the console 100 via the lower pogo pins 422 and the upper pogo pins 432.

The present disclosure has been made in an effort to solve the above-described problems associated with the prior art, and it is an object of the present disclosure to provide a vehicle moving console device configured to lock and fix a console to a desired position on a seamless long sliding rail mounted on a floor panel, to unlock the console from the long sliding rail so as to move the console to a desired position on the long sliding rail, to readily supply power to electrical components included in the console even if the console is moved to the desired position, and to remove the console from the long sliding rail so as to maximally utilize the interior space of a vehicle.

In one aspect, the present disclosure provides a vehicle moving console device including a pair of rails mounted on a floor panel, wheels respectively mounted on lower portions of opposite sides of a console, the wheels being respectively mounted on the rails so as to be movable forwards and rearwards along the rails, a locking device mounted on the console and the rails, the locking device being configured to lock the console to the rails or unlock the console from the rails such that the console is movable along the rails or is removable therefrom, a locking release lever mounted on a predetermined position of the console, the locking release lever being configured to unlock the locking device, a fixed plate configured to connect the rails to each other, and a power supply device for an electrical component, the power supply device being mounted on the fixed plate and the console.

In an example, the locking release lever may include a first release lever mounted at a predetermined position on a front side of the console, the first release lever being configured to unlock the locking device, and a second release lever mounted at a predetermined position on a rear side of the console.

In another example, the locking device may include a slider vertically movably mounted at a predetermined position on an inner surface of the console, wherein the slider is connected to the first release lever by a first cable and is connected to the second release lever by a second cable, at least three upper locking brackets each having a locking pin lifting/lowering hole formed therein, the upper locking brackets being respectively mounted on lower portions of the opposite sides of the console with a predetermined interval therebetween in a forward-and-rearward direction, at least three lower locking brackets each having a locking pin locking hole formed therein, the lower locking brackets being respectively mounted on outer portions of the rails with a predetermined interval therebetween in the forward-and-rearward direction, a locking pin inserted into the locking pin lifting/lowering hole so as to be movable upwards and downwards therein, the locking pin being inserted into the locking pin locking hole so as to be locked therein, a locking pin lifting/lowering operation lever hinged to the upper locking bracket and connected to a tip of the locking pin, a link device connected to the slider in a foldable manner, and a third cable configured to connect the locking pin lifting/lowering operation lever to the link device.

In still another example, the slider may have a connection end formed on an upper portion thereof, the connection end having a connection hole formed therein and configured for the first cable and the second cable to pass therethrough and to be inserted thereinto, and each of the first cable and the second cable may have a cable fixing cap attached to an end thereof, the cable fixing cap being caught on a bottom surface of the connection end.

In yet another example, a lifting/lowering guide body may be formed to extend from the connection end of the slider downwards, and the console may have a lifting/lowering guide rail mounted at a predetermined position on the inner surface thereof, the lifting/lowering guide rail being configured for the lifting/lowering guide body to be inserted thereinto in a vertically movable manner.

In still yet another example, the lifting/lowering guide rail may have a lifting/lowering guide hole formed therein and configured for the lifting/lowering guide body to be inserted thereinto in the vertically movable manner.

In a further example, each of the upper locking brackets mounted on the console may have a locking groove formed in a lower inner surface thereof, and each of the lower locking brackets may have a locking end formed on an upper outer surface thereof, wherein the locking end is inserted into and coupled to the locking groove so as to be movable forwards and rearwards.

In another further example, each of the upper locking brackets may have a hinge end formed on an upper end thereof, and the locking pin lifting/lowering operation lever may have a hinge groove formed in an inner surface thereof, the hinge groove being configured for the hinge end to be inserted thereinto and coupled thereto.

In still another further example, a cable connection end connected to the third cable and a lifting end configured to move the locking pin upwards may be respectively formed on an upper side and an outer side of the hinge groove of the locking pin lifting/lowering operation lever.

In yet another further example, the locking pin may have a first electrode attached to an upper front surface thereof, the first electrode being connected to a (+) power source, and a second electrode may be attached to a portion between the cable connection end and the lifting end of the locking pin lifting/lowering operation lever, the second electrode being connected to a (-) power source so as to be in contact with the first electrode.

In still yet another further example, the link device may include intermediate links having upper portions respectively hinged to opposite ends of the slider, and driving links respectively having middle portions hinged to a predetermined position on the inner surface of the console, wherein the driving links have inclined links respectively formed on upper portions of the middle portions, the inclined links being respectively hinged to lower portions of the intermediate links, and the driving links have cable pulling links respectively formed on lower portions of the middle portions, each of the cable pulling links being connected to the third cable so as to allow the third cable to be pulled by each of the cable pulling links.

In a still further example, the console may have detachable brackets respectively mounted on lower ends of the opposite sides of the console, wherein the detachable brackets are detachably coupled to the respective lower locking brackets and are arranged between the upper locking brackets.

In a yet still further example, each of the detachable brackets may have an elastic hook formed on a lower portion thereof, the elastic hook being detachably coupled to the locking end of each of the lower locking brackets.

In another example, the elastic hook may have an inclined surface formed on a bottom surface thereof, wherein the inclined surface is formed to be inclined at a predetermined angle relative to an upper surface of the locking end so as to allow the elastic hook to be smoothly mounted on and removed from the locking end.

In still another example, the power supply device may include a fixed housing mounted on the fixed plate, a plurality of lower pogo pins mounted on an upper surface of the fixed housing in a predetermined arrangement, the lower pogo pins being configured to receive power from a controller, a movable housing mounted on a lower portion of the console so as to be moved with the console, and a plurality of upper pogo pins mounted on a lower surface of the movable housing in a predetermined arrangement so as to be in conductive contact with the lower pogo pins.

In yet another example, the console may have a screw coupling end formed on a bottom surface thereof, and the movable housing may have coupling holes respectively formed at a front portion and a rear portion thereof, each of the coupling holes being configured for the screw coupling end to be inserted therethrough.

In still yet another example, a screw may be coupled to the screw coupling end inserted through the coupling hole, and a stopper configured to support a bottom surface of the movable housing may be coupled to a head portion of the screw.

In a further example, the screw coupling end may have springs arranged in a circumferential portion thereof, the springs being arranged to be compressible between an upper surface of the movable housing and a lower surface of the console.

In another further example, the movable housing may have slide protrusions respectively formed at front and rear portions on a bottom surface thereof, wherein each of the slide protrusions is inclined at a predetermined inclination angle so as to contact a corresponding one of a front corner portion and a rear corner portion of the fixed housing.

In still another further example, the movable housing may have tolerance absorbing protrusions respectively formed at both portions on a bottom surface thereof, and the fixed housing may have tolerance absorbing grooves respectively formed in both portions on an upper surface thereof, the tolerance absorbing grooves being configured for the tolerance absorbing protrusions to be respectively inserted thereinto and coupled thereto.

Other aspects and examples of the disclosure are discussed infra.

As is apparent from the above description, the present disclosure provides the following effects.

First, a console may be locked and used at a desired position of a seamless long sliding rail using a console locking device. Further, after being unlocked from the long sliding rail, the console may be readily moved to a desired position of the long sliding rail.

Second, even if the console is moved to the desired position, a power supply device configured to supply power and mounted on the long-sliding rail and a power supply device configured to receive power and mounted on the console are in contact with each other so as to maintain the conductive state therebetween, thereby reliably supplying power to electrical components included in the console.

Third, when the interior space of the vehicle needs to be expanded, the console may be easily removed from the long sliding rail through a console removal device.

Fourth, when the console is locked at the desired position of the long sliding rail, the locking state of the console is reliably detected so as to prevent the console from being detached from the long sliding rail due to incomplete locking.

Although the present disclosure has been described in detail with reference to examples thereof, the scope of the present disclosure is not limited to the above-described examples and the accompanying drawings, and it will be appreciated by those skilled in the art that various modifications and improvements may be made in the examples without departing from the principles and spirit of the disclosure, the scope of which is defined in the appended claims and equivalents thereto.

What is claimed is:

1. A vehicle moving console device comprising:
rails mounted on a floor panel;
wheels mounted on lower portions of opposite sides of a console and configured to be mounted on the rails so as to be movable forwards and rearwards along the rails;
a lock, mounted on the console and the rails, configured to be locked to lock the console to the rails such that the console is movable along the rails, or to be unlocked to unlock the console from the rails such that the console is removable from the rails;
a locking release lever, mounted on the console, configured to unlock the lock;
a fixed plate configured to connect the rails; and
a power supply mounted on the fixed plate and the console.

2. The vehicle moving console device of claim 1, wherein the locking release lever comprises:
a first release lever, mounted on a front side of the console, configured to unlock the lock; and
a second release lever, mounted on a rear side of the console, configured to unlock the lock.

3. The vehicle moving console device of claim 2, wherein the lock comprises:
a slider vertically movably mounted on an inner surface of the console, wherein the slider is connected to:
the first release lever by a first cable; and
the second release lever by a second cable;
at least three upper locking brackets mounted on lower portions of each side of the opposite sides of the console in a forward-and-rearward direction, wherein a locking pin lifting/lowering hole is formed in each of the at least three upper locking brackets;
at least three lower locking brackets mounted on outer portions of each rail of the rails in the forward-and-rearward direction, wherein a locking pin locking hole is formed in each of the at least three lower locking brackets;
locking pins each inserted into, and vertically movable in, a corresponding one of the locking pin lifting/lowering holes and configured to be inserted into a corresponding one of the locking pin locking holes so as to be locked therein;
locking pin lifting/lowering operation levers each hinged to a corresponding one of the upper locking brackets and connected to a tip of a corresponding one of the locking pins;
a link device connected to the slider in a foldable manner; and
a third cable configured to connect one of the locking pin lifting/lowering operation levers to the link device.

4. The vehicle moving console device of claim 3, wherein an upper portion of the slider a connection end that forms a connection hole, wherein the first cable and the second cable pass through and are inserted into the connection hole, and the first cable has a first end attached to a first cable fixing cap caught on a bottom surface of the connection end and the second cable has a first end attached to a second cable fixing cap caught on the bottom surface of the connection end.

5. The vehicle moving console device of claim 4, wherein a lifting/lowering guide body extends downward from the connection end of the slider, and the console comprises a lifting/lowering guide rail mounted on the inner surface of the console so as to be configured to accommodate insertion of the lifting/lowering guide body in a vertically movable manner.

6. The vehicle moving console device of claim 5, wherein the lifting/lowering guide rail forms a lifting/lowering guide hole configured to accommodate insertion of the lifting/lowering guide body in the vertically movable manner.

7. The vehicle moving console device of claim 3, wherein each of the upper locking brackets mounted on the console comprises a lower inner surface that forms a locking groove, and each of the lower locking brackets comprises an upper outer surface that forms a locking end, and wherein the locking end is inserted into and coupled to a corresponding one of the locking grooves so as to be movable forwards and rearwards.

8. The vehicle moving console device of claim 3, wherein each of the upper locking brackets comprises an upper end that forms a hinge end, and the locking pin lifting/lowering operation levers each comprises an inner surface that forms a hinge groove, wherein each of the hinge ends is inserted into a corresponding one of the hinge grooves.

9. The vehicle moving console device of claim 8, wherein a cable connection end connected to the third cable is formed on an upper side of one of the hinge grooves and a lifting end configured to move one of the locking pins upwards is formed on an outer side of the one of the hinge grooves.

10. The vehicle moving console device of claim 9, wherein the one of the locking pins, comprises an upper front surface attached to a first electrode connected to a first polarity power source, and a second electrode is attached to a portion between the cable connection end and the lifting end of one of the locking pin lifting/lowering operation levers, the second electrode being connected to a second polarity power source.

11. The vehicle moving console device of claim 3, wherein the link device comprises:
intermediate links having upper portions respectively hinged to opposite ends of the slider; and
driving links having middle portions hinged to the inner surface of the console, wherein inclined links are respectively formed on upper portions of the middle portions, the inclined links being respectively hinged to lower portions of the intermediate links, and wherein the driving links comprise cable pulling links, respectively formed on lower portions of the middle portions, connected to the third cable so as to allow the third cable to be pulled by each of the cable pulling links.

12. The vehicle moving console device of claim 7, wherein the console comprises detachable brackets respectively mounted on lower ends of the opposite sides of the console, and wherein the detachable brackets are detachably coupled to the lower locking brackets and are arranged between the upper locking brackets.

13. The vehicle moving console device of claim 12, wherein each of the detachable brackets comprises a lower portion forming an elastic hook, wherein the elastic hooks of the detachable brackets are configured to be detachably coupled to the locking ends of the lower locking brackets.

14. The vehicle moving console device of claim 13, wherein each of the elastic hooks comprises a bottom surface that comprises an inclined surface formed to be inclined at a predetermined angle relative to an upper surface of a corresponding locking end, of the locking ends, so as to allow the elastic hook to be smoothly mounted on and removed from the locking end.

15. The vehicle moving console device of claim 1, wherein the power supply comprises:
a fixed housing mounted on the fixed plate;
a plurality of lower pogo pins, mounted on an upper surface of the fixed housing, configured to receive power from a controller;
a movable housing mounted on a lower portion of the console so as to be configured to move with the console; and
a plurality of upper pogo pins mounted on a lower surface of the movable housing so as to be in conductive contact with the lower pogo pins.

16. The vehicle moving console device of claim 15, wherein the console comprises a bottom surface that forms a screw coupling end, and front and rear portions of the movable housing form coupling holes configured to accept insertion of the screw coupling end.

17. The vehicle moving console device of claim 16, wherein a screw is coupled to the screw coupling end inserted through one of the coupling holes, and a stopper, coupled to a head portion of the screw, is configured to support a bottom surface of the movable housing.

18. The vehicle moving console device of claim 16, wherein the screw coupling end comprises springs arranged in a circumferential portion thereof, and wherein the springs are configured to be compressible between an upper surface of the movable housing and a lower surface of the console.

19. The vehicle moving console device of claim 15, wherein the movable housing comprises slide protrusions respectively formed at front and rear portions on a bottom surface of the movable housing, and wherein each of the slide protrusions is inclined so as to contact a corresponding one of a front corner portion and a rear corner portion of the fixed housing.

20. The vehicle moving console device of claim 15, wherein the movable housing comprises tolerance absorbing protrusions formed at front and rear portions on a bottom surface of the movable housing, and the fixed housing comprises tolerance absorbing grooves, respectively formed in the front and rear portions on an upper surface of the fixed housing, the tolerance absorbing grooves being configured to accept insertion of the tolerance absorbing protrusions.
